(19) United States
(12) Patent Application Publication
(10) Pub. No.: US 2015/0130762 A1
(43) Pub. Date: May 14, 2015

(54) PERIPHERAL DEVICE WITH TOUCH CONTROL FUNCTION

(71) Applicant: Darfon Electronics Corp., Taoyuan Shien (TW)

(72) Inventor: Chih-An Wang, Taoyuan County (TW)

(73) Assignee: Darfon Electronics Corp., Taoyuan Shien (TW)

(21) Appl. No.: 14/540,026

(22) Filed: Nov. 12, 2014

(30) Foreign Application Priority Data
Nov. 14, 2013 (TW) 102221310

(51) Int. Cl. G06F 3/044; G06F 3/0488; G06F 3/045

(52) U.S. Cl. CPC G06F 3/044; G06F 3/045; G06F 3/04886
USPC 345/174

(57) ABSTRACT

A peripheral device comprises a control unit and an operating body. The operating body electrically coupled to the control unit comprises a keyboard layout layer, a capacitance sensing layer and a resistance sensing layer. The keyboard layout layer shows a keyboard layout to be operated. The capacitance sensing layer disposed beneath the keyboard layout layer is capable to detect a finger contact and generate a contact path according to the finger contact. The resistance sensing layer, which is disposed under the keyboard layout layer, stacked with the capacitance sensing layer, is capable to detect a pressing operation on the keyboard layout layer and generates a press signal according to the pressing operation.

This application claims the benefit of Taiwan application Serial No. 102221310, filed Nov. 14, 2013, the subject matter of which is incorporated herein by reference.

### BACKGROUND OF THE INVENTION

1. Field of the Invention

The invention relates in general to a peripheral device, and more particularly to a peripheral device with a touch control function.

2. Description of the Related Art

With the popularization of the electronic devices, such as personal computers and notebook computers, peripheral devices used in conjunction with these electronic devices are also widely applied. Conventionally, in order to provide the user the keyboard operation and the mouse operation, a touch pad is additionally disposed outside the keyboard region in addition to the individual devices, such as the keyboard and the mouse, to be operated. However, the devices, such as the keyboard and the mouse, need to occupy the larger space and cannot be easily carried, and the touch pad disposed outside the keyboard region cannot be easily operated and also enlarges the size of the keyboard.

Thus, it is an important subject in the industry to provide a peripheral device, which can be easily operated and used by the user.

### SUMMARY OF THE INVENTION

The invention is directed to a peripheral device having a touch control function and facilitating the user in performing the gesture operation and the keyboard operation.

According to a first aspect of the present invention, a peripheral device is provided. The peripheral device comprises a control unit and an operating body electrically coupled to the control unit. The operating body comprises a keyboard layout layer showing a plurality of keys to be operated, the plurality of keys comprising a modifier key, the keyboard layout layer defining a first operating area and a second operating area, the modifier key being located within the first operating area, but located outside the second operating area; a capacitance sensing layer disposed beneath the keyboard layout layer capable to detect a finger contact and generate a contact path according to the finger contact; and a resistance sensing layer, which is disposed under the keyboard layout layer, stacked with the capacitance sensing layer, capable to detect a pressing operation on the keyboard layout layer and generate a press signal according to the pressing operation; wherein when the resistance sensing layer detects a pressing operation occurs at a location corresponding to the modifier key, the control unit enables the capacitance sensing layer to detect the finger contact in the second operating area to generate the contact path. When the resistance sensing layer detects no pressing operation occur at the location corresponding to the modifier key, the control unit enables the capacitance sensing layer to detect the finger contact in the first operating area to generate the contact path.

According to a second aspect of the present invention, a peripheral device is provided. The peripheral device comprises a control unit and an operating body electrically coupled to the control unit. The operating body comprises a keyboard layout layer showing a plurality of keys to be operated, the plurality of keys comprising a modifier key, the keyboard layout layer defining a first operating area and a second operating area, the modifier key being located within the first operating area, but located outside the second operating area; a capacitance sensing layer disposed beneath the keyboard layout layer capable to detect a finger contact and generate a contact path according to the finger contact; and a resistance sensing layer, which is disposed under the keyboard layout layer, stacked with the capacitance sensing layer, capable to detect a pressing operation on the keyboard layout layer and generate a press signal according to the pressing operation. When the operating body operated by a user finger to enable the resistance sensing layer to generate the press signal, and simultaneously enable the capacitance sensing layer generates the contact path whose length is shorter than a predetermined length, the control unit ignores the contact path and only outputs the press signal to the host.

According to a third aspect of the present invention, a peripheral device is provided. The peripheral device comprises a control unit and an operating body electrically coupled to the control unit. The operating body comprises a keyboard layout layer showing a plurality of keys to be operated, the plurality of keys comprising a modifier key, the keyboard layout layer defining a first operating area and a second operating area, the modifier key being located within the first operating area, but located outside the second operating area; a capacitance sensing layer disposed beneath the keyboard layout layer capable to detect a finger contact and generate a contact path according to the finger contact; and a resistance sensing layer, which is disposed under the keyboard layout layer, stacked with the capacitance sensing layer, capable to detect a pressing operation on the keyboard layout layer and generate a press signal according to the pressing operation. When both the contact path and the press signal are simultaneously generated, when (a) a length of the contact path is smaller than a predetermined value, and (b) the contact path is a single-touch gesture, the control unit ignores the contact path and outputs the press signal to the host. When (a) the length of the contact path is greater than the predetermined value, or (b) the contact path is a multi-touch gesture, the control unit ignores the press signal and outputs the contact path to the host.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram showing a peripheral device according to an embodiment of the invention.

FIG. 2 is a schematic view showing an operating body of the peripheral device.

FIG. 3 shows a first operating area and a second operating area defined by a keyboard layout layer.

FIG. 4 is a block diagram showing a control unit.

FIG. 5 is a flow chart showing an operating method of the peripheral device according to a first embodiment of the invention.

FIG. 6 is a schematic view showing a user operating a keyboard layout layer to generate a contact path with a length 51.

FIG. 7 is a schematic view showing a time interval defining a contact path, which needs to be ignored.

FIG. 8 is a flow chart showing an operating method of a peripheral device according to a second embodiment of the invention.

FIG. 9 is a schematic view showing a user operating the keyboard layout layer to generate a contact path with a length S2.

FIG. 10 is a flow chart showing an operating method of a peripheral device according to a third embodiment of the invention.

FIG. 11A is a schematic view showing multi-touch gestures of zoom-in and zoom-out finger contacts applied to the keyboard layout layer.

FIG. 11B is a schematic view showing a multi-touch gesture of a “rotate” finger contact applied to the keyboard layout layer.

### DETAILED DESCRIPTION OF THE INVENTION

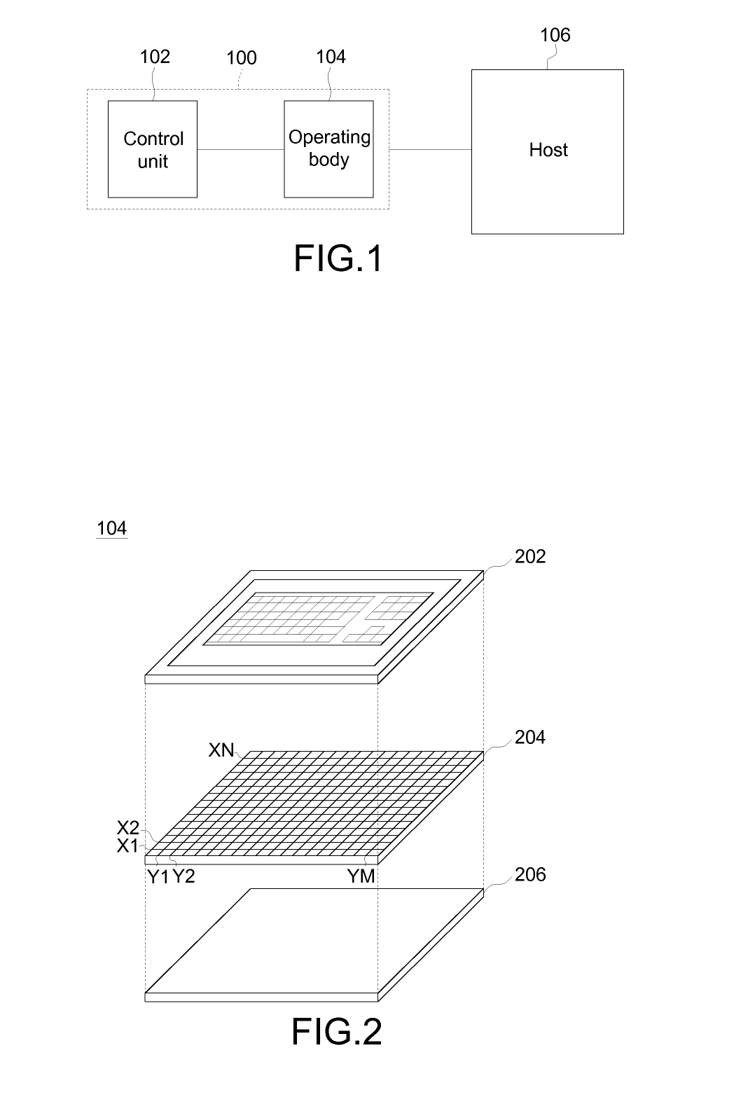

FIG. 1 is a block diagram showing a peripheral device 100 according to an embodiment of the invention. FIG. 2 is a schematic view showing an operating body of the peripheral device. Referring to FIGS. 1 and 2, the peripheral device 100 has a control unit 102 and an operating body 104. The operating body 104 electrically coupled to the control unit 102 comprises a keyboard layout layer 202, a capacitance sensing layer 204 and a resistance sensing layer 206. The keyboard layout layer 202 shows a plurality of keys to be operated. The plurality of keys comprises a modifier key. The capacitance sensing layer 204 is disposed beneath the keyboard layout layer 202 and is capable to detect a finger contact and generate a contact path according to the finger contact. In one embodiment, the capacitance sensing layer 204 comprises X-Y electrodes (denoted by X1 to XN, and Y1 to YM, where N and M are positive integers greater than 1) arranged alternately, and is disposed beneath the keyboard layout layer 202. A substantially horizontal motion track of a user's finger can be detected by scanning the electrodes, and then the user's finger contact can be recognized according to the motion track. The resistance sensing layer 206, which is disposed under the keyboard layout layer 202 and stacked with the capacitance sensing layer, is capable to detect a pressing operation on the keyboard layout layer 202 and generates a press signal according to the pressing operation. In one embodiment, the resistance sensing layer 206 comprises a plurality of independent switches for detecting a substantially vertical pressing operation of the user's finger at different positions, and generates a press signal corresponding to the pressing position according to the pressing operation.

In one example, the peripheral device 100 communicates with a host 106 in a wired or wireless manner. By stacking the keyboard layout layer 202, the capacitance sensing layer 204 and resistance sensing layer 206 on the operating body 104, the user can easily perform the operation, equivalent to the computer peripheral device, such as the keyboard or mouse, on the host 106 through the keyboard layout, displayed on the keyboard layout layer 202. Taking a standard keyboard layout as an example of the keyboard layout, the user can make the resistance sensing layer 206 generate a corresponding press signal by substantially vertically pressing a keyboard pattern in the keyboard layout, in order to perform a corresponding keyboard operation (e.g., typing input) on the host 106. In addition, the user may also operate a touch pen or the finger to directly substantially horizontally slide over the keyboard layout layer 202, so that the capacitance sensing layer 204 generates a corresponding contact path to perform the gesture operation, similar to the mouse function, on the host 106.

For example, the host 106 is a personal computer, a notebook computer, a tablet computer or any other electronic device capable of executing an ordinary application program. The control unit 102 of the peripheral device 100 is, for example, a processor or any other electronic calculation device capable of controlling the operating body 104. For example, the keyboard layout layer 202 of the operating body 104 comprises an organic light emitting diode (OLED) layer capable of displaying a corresponding keyboard layout according to the control signal outputted from the control unit 102. For example, the electrodes of the capacitance sensing layer 204 comprise row electrodes X1 to XN and column electrodes Y1 to YM. The row electrodes X1 to XN are orthogonal to the column electrodes Y1 to YM, for example. The control unit 102 scans the row electrodes X1 to XN and the column electrodes Y1 to YM, respectively, to detect the user's finger contact. The resistance sensing layer 206 comprises, for example, switch elements, which turn on in response to an external pressing force and thus generates the press signal.

In an application example, the capacitance sensing layer 204 may detect the touch force of the finger contact. When this finger contact is a single-touch gesture and the touch force is smaller than a touch threshold value (e.g., about 60 grams (g) of external force), it represents that the left key of the mouse is operated. On the contrary, when the finger contact is a multi-touch gesture and the touch force is smaller than the touch threshold value, it represents that the right key of the mouse is operated. Consequently, as long as the touch force upon the user's operation is smaller than the threshold value, the click operations the same as the left key and the right key of the mouse can be directly performed on the keyboard layout layer 202.

Upon researching, it is found that, when a predetermined force (e.g., the external force greater than 60 g) is exerted to press the operating body 104, the capacitance sensing layer 204 and the resistance sensing layer 206 simultaneously generates the contact path and the press signal. The two signals correspond to the gesture operation (similar to the mouse operation) and the keyboard operation, respectively. In order to prevent the malfunction (e.g., the text input point is shifted due to the contact path upon text inputting) and reduce the program judgment difficulty, three embodiments are provided in the following to further integrate the gesture operation function and the keyboard operation function of the peripheral device 100.

### First Embodiment

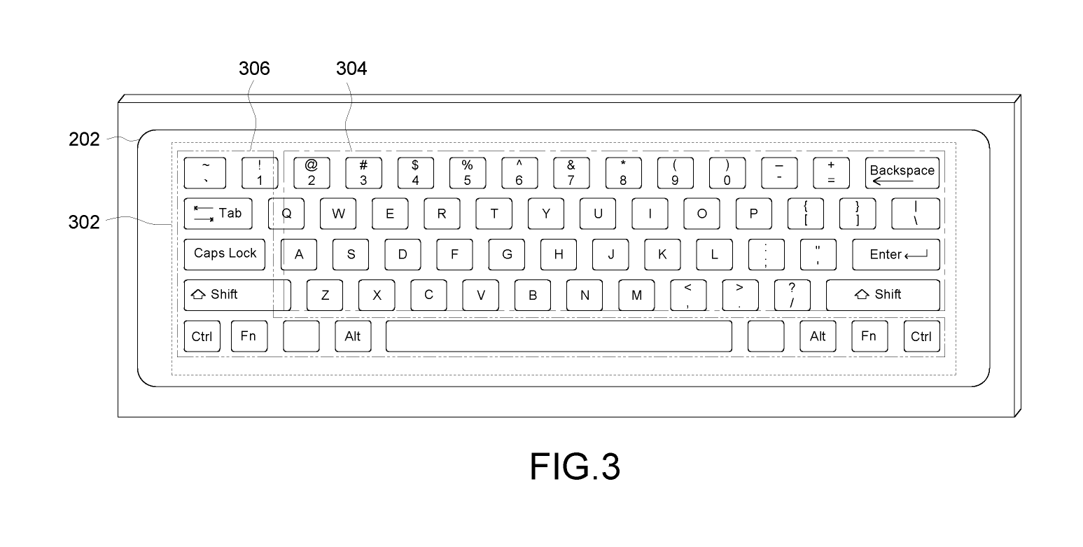

Referring to the embodiment of FIG. 3, the keyboard layout layer 202 defines a first operating area 302, a second operating area 304. Modifier keys, such a Shift key, Ctrl key, Alt key and the like, are located within the first operating area 302, but located outside the second operating area 304. In the example of FIG. 3, the keyboard layout layer 202 further comprises a modified key area 306 which is the difference between the first operating area 302 and the second operating area 304, and the modifier key is located in the modifier key area 306. The second operating area 304 is a partial region of the first operating area 302. When the resistance sensing layer 206 detects a pressing operation occurs at a location corresponding to the modifier key, the control unit 102 enables the capacitance sensing layer 204 to detect the finger contact in the second operating area 304 to generate the contact path. For example, only the second operating area 304 is detected. On the contrary, when the resistance sensing layer 206 detects no pressing operation occur at the location corresponding to the modifier key, the control unit 102 enables the capacitance sensing layer 204 to detect the finger contact in the first operating area 302 to generate the contact path. Consequently, when the user wants to perform a copy operation by pressing the modifier key (e.g., Ctrl key or Shift key) in the first operating area 302 in conjunction with the finger contact to click (or to marquee by drag and drop) multiple document in the host 106, the control unit 102 enables the capacitance sensing layer 204 to only detect the finger contact in the second operating area 304. So, at this time, the modifier key area 306 only has the keyboard operation function, and the modifier key area 306 cannot simultaneously generate any contact path signal. Therefore, this embodiment can effectively reduce the difficulty of the program in judging the operation of the modifier key.

Furthermore, in this embodiment, when the resistance sensing layer 206 detects the pressing operation occurs at the location corresponding to an arbitrary modifier key in the modifier key area 306, the control unit 102 enables (a) the resistance sensing layer 206 to still detect the pressing operation in the overall first operating area 302 to generate the press signal, and enables (b) the capacitance sensing layer to only detect the finger contact in the region other than the modifier key area 306 to generate the contact path. For example, only the second operating area 304 is detected. Consequently, the program can clearly judge the combination operation performed in conjunction with the modifier key according to the press signal corresponding to the first operating area and the contact path corresponding to the second operating area.

FIG. 3 shows an example of a first operating area and a second operating area defined by the keyboard layout layer 202. As shown in FIG. 3, the first operating area 302 is the sum of the second operating area 304 and the modifier key area 306. That is, the second operating area 304 is the remaining region of the first operating area 302 after the modifier key area 306 is eliminated, whereas the modifier key is disposed in the modifier key area 306. In this example, the second operating area 304 comprises 26 English alphabet keys and 10 numeric keys, and the modifier key area 306 is an L-shaped area located on the lower left side of the second operating area 304. At least one of a Shift key, a Ctrl key and an Alt key is located within the L-shaped area.

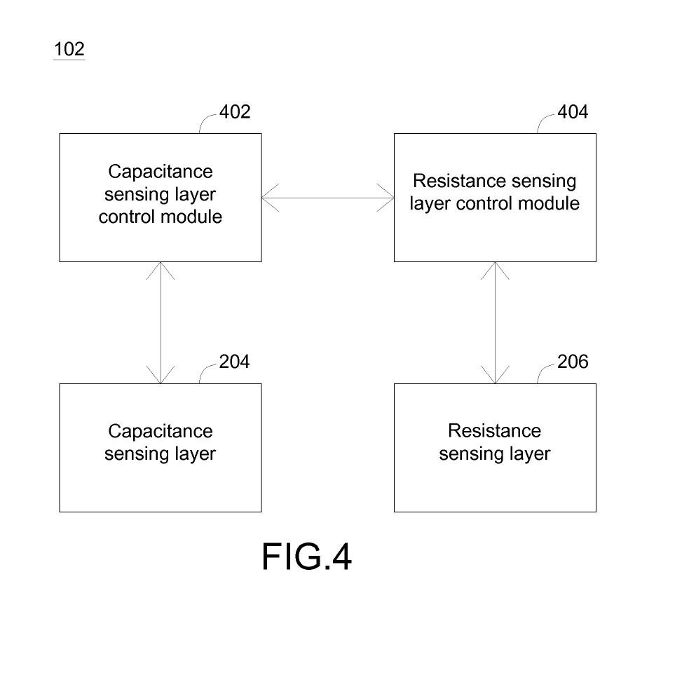

FIG. 4 is a block diagram showing the control unit 102. Referring to FIG. 4, the control unit 102 comprises a capacitance sensing layer control module 402 and a resistance sensing layer control module 404. The capacitance sensing layer control module 402 is for controlling the electrodes of the capacitance sensing layer 204. The resistance sensing layer control module 404 is for providing a press position signal to the capacitance sensing layer control module 402 according to the pressing operation detected by the resistance sensing layer 206. When the capacitance sensing layer control module 402 selectively disables a portion of the column electrodes and a portion of the row electrodes according to the press position signal, but the other portion of the column electrodes and the other portion of the row electrodes corresponding to the second operating area are still enabled.

For example, when the resistance sensing layer 206 detects the pressing operation occurs at the location corresponding to the modifier key (e.g., the Ctrl key at the lower left corner in the keyboard layout of FIG. 3), the control unit 102 disables a portion of the column electrodes and a portion of the row electrodes passing through the location corresponding to the modifier key to stop scanning the finger contact corresponding to the modifier key area 306 (comprising the position corresponding to the pressed modifier key). Consequently, the capacitance sensing layer 204 generates the corresponding contact path only for the detected finger contact in the region (e.g., the second operating area 304) where the scanning is not stopped.

In another example, when the resistance sensing layer 206 detects the pressing operation corresponding to the modifier key, the control unit 102 disables a portion of the column electrodes and a portion of the row electrodes corresponding to the position of the modifier key according to the position, where the pressing operation is detected. For example, if the position of a certain modifier key corresponds to the column electrodes Y3 to Y6 and the row electrodes X3 to X6, then when the resistance sensing layer 206 detects the pressing operation corresponding to the modifier key (the pressing operation corresponding to, for example, the positions of the column electrodes Y3 to Y6 and the row electrodes X3 to X6), the control unit 102 disables a portion of the column electrodes (e.g., the column electrodes Y3 to Y6) and a portion of the row electrodes (e.g., the row electrodes X3 to X6) corresponding to the position of the modifier key according to the position, where the pressing operation is detected.

In brief, the control unit 102 can only detect the finger contact in the second operating area 304 by disabling a portion of the row electrodes and a portion of the column electrodes of the capacitance sensing layer 204 corresponding to the modifier key area 306.

In addition, in this embodiment, after the pressing operation ends for a period of time exceeding a predetermined time interval (e.g., 1 millisecond (msec)), the control unit 102 can enable the disabled portion of the column electrodes and the disabled portion of the row electrodes corresponding to the modifier key area 306 again. For example, in FIG. 3, after the pressing operation ends for the period of time exceeding a predetermined time interval, the control unit 102 can enable the disabled portion of the column electrodes and the disabled portion of the row electrodes again, so that the operating area of the keyboard layout layer 202 capable of detecting the touch gesture recovers from the smaller second operating area 304 to the larger first operating area 302.

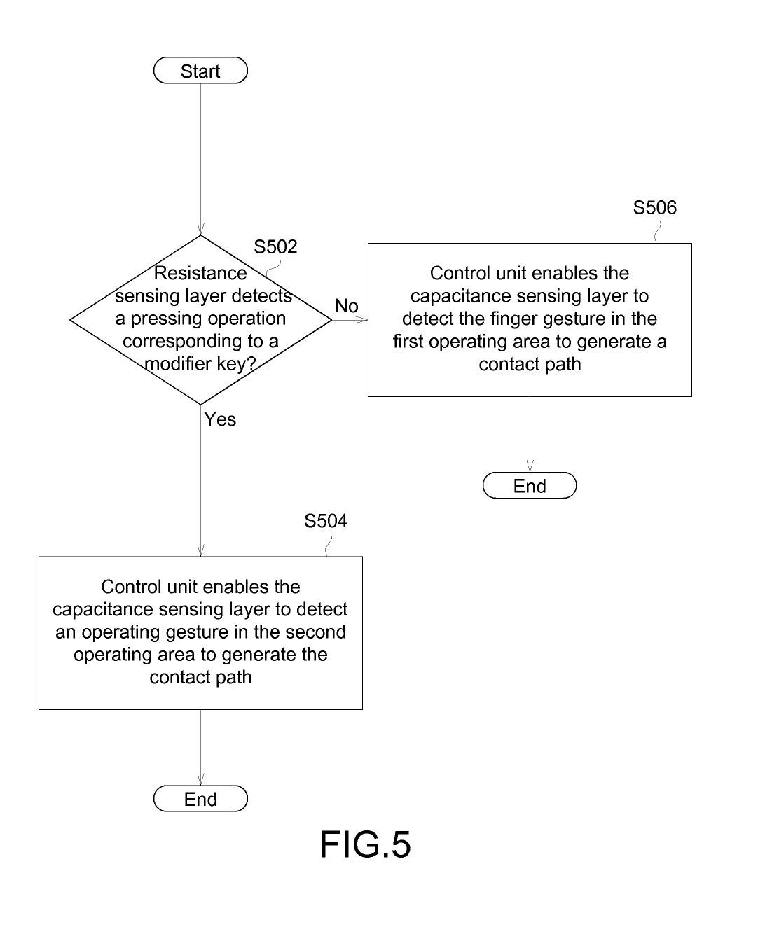

FIG. 5 is a flow chart showing an operating method of the peripheral device according to the first embodiment of the invention. The operating method comprises the following steps. First, in step S502, the resistance sensing layer 206 detects whether a pressing operation corresponding to any modifier key is present. Next, in step S504, when the resistance sensing layer 206 detects the pressing operation corresponding to an arbitrary modifier key, the control unit 102 eliminates the modifier key area 306 so that the capacitance sensing layer 204 only detects the finger contact in the second operating area 304 to generate the contact path. Alternatively, in step S506, when the resistance sensing layer 206 detects no pressing operation occurs at the location corresponding to any modifier key, the control unit 102 enables the capacitance sensing layer 204 to detect the finger contact in the complete first operating area 302 to generate the contact path.

To sum up, the peripheral device of this embodiment can selectively disable the electrodes of the capacitance sensing layer to prevent the pressed modifier key area from simultaneously generating the contact path and the press signal so as to effectively reduce the difficulty of the program in judging the operation of the modifier key.

### Second Embodiment

In this embodiment, when the operating body 104 is operated by a user to make the contact path and the press signal simultaneously generated from the capacitance sensing layer 204 and the resistance sensing layer 206 respectively, if the length of the contact path is shorter than a predetermined length, then the control unit 102 ignores the contact path and only outputs the press signal to the host 106. Consequently, when the user wants to perform the text inputting and even when the contact path and the press signal are simultaneously generated when the keyboard is pressed, the contact path having the length smaller than the predetermined length is ignored. So, this embodiment can effectively prevent the text input point or the cursor position from being affected by the contact path. In addition, it is to be noted that this embodiment can be combined with other embodiments described in the specification of the invention.

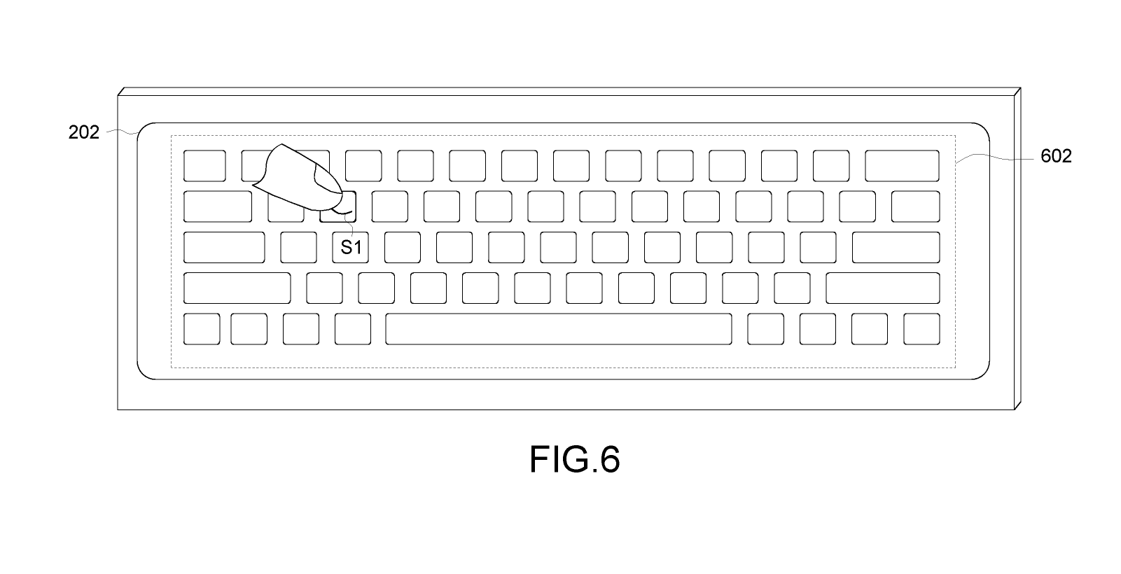

FIG. 6 is a schematic view showing a user operating the keyboard layout layer 202 to generate a contact path with a length S1. As shown in FIG. 6, a certain key (represented by the thick frame) in a keyboard layout 602 is pressed. Furthermore, when the external pressing force exceeds a press threshold value (e.g., is substantially equal to the force of 60 g), the switch of the resistance sensing layer 206 is turned on representing the pressing operation is detected. At this time, the position of the pressing operation detected by the resistance sensing layer 206 at a location corresponding to this key, so the press signal outputted from the control unit 102 to the host 106 is the key code corresponding to this key. For example, if this pressed key is the letter key “W”, then the control unit 102 outputs the key code corresponding to the letter key “W” to the host 106.

When the user is pressing the key, the force exerting position is usually not fixed at the desired key input point (e.g., the finger may slightly slide upon pressing the key), so the contact path tends to be accompanied. As shown in FIG. 6, the length of the contact path in the letter key “W” is the length S1. When this length S1 is smaller than a predetermined length, the control unit 102 will not output the contact path to the host 106. The predetermined length substantially ranges from 3 mm to 5 mm. However, it is understood that the predetermined length of this embodiment may be adjusted according to the size of the keyboard pattern or key cap region in the keyboard layout as long as the predetermined length does not exceed, for example, one third of the width of the keyboard pattern or key cap region.

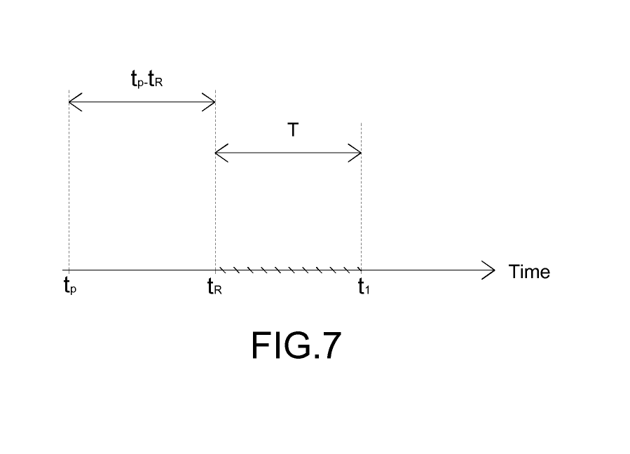

FIG. 7 shows that the control unit 102 will keep ignoring the contact path for a predetermined time interval T (i.e., the starting time point t_{R} to the time instant t₁) since the starting time point t_{R} when the resistance sensing layer 206 detects the pressing operation at the starting time point t_{R}. Consequently, the minor displacement generated when the user uses the finger (or touch pen) to press the key will not generate the unessential offset on the position of the key input point.

In another example, the control unit 102 can ignore the contact path in a time interval comprising the time instant t_{R}. For example, the control unit 102 ignores the contact path generated in a specific time interval tₚ-t_{R} (the control unit 102 is still processing the contact path and has not outputted the processed result to the host 106) before the time instant t_{R}, and the contact path generated in a specific time interval t_{R}-t₁ after the time instant t_{R}. Consequently, even if the capacitance sensing layer 204 is firstly touched to generate the unessential contact path in the key pressing process, the control unit 102 still can ignore the contact path to prevent the position of the key input point from being affected.

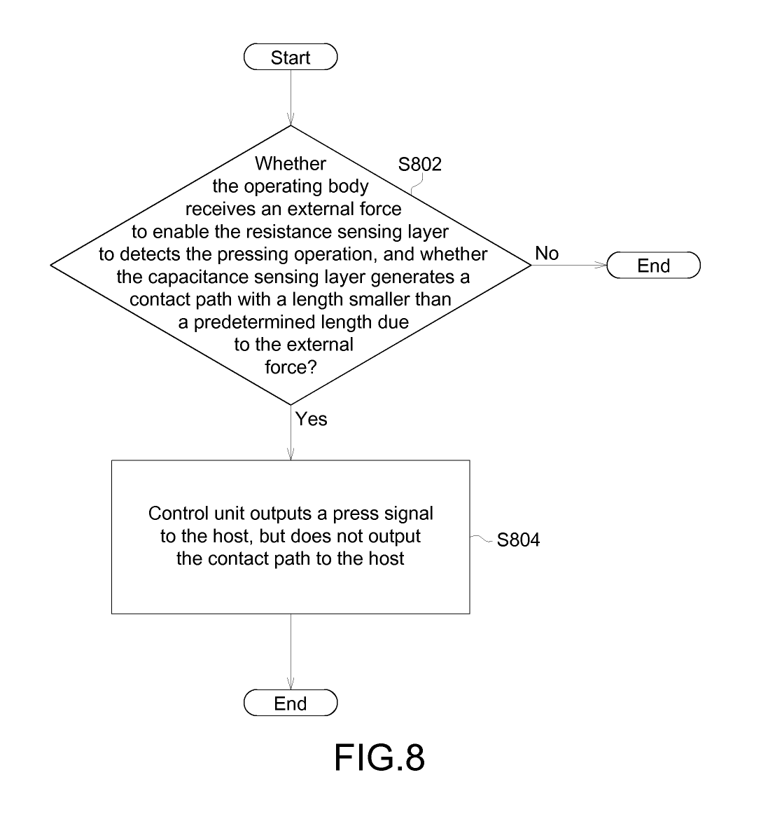

FIG. 8 is a flow chart showing an operating method of a peripheral device according to a second embodiment of the invention. Referring to FIG. 8, the operating method comprises the following steps. First, at step S802, the resistance sensing layer 206 detects the pressing operation at the time instant Tr, while the capacitance sensing layer 204 detects the user's gesture operation. Next, in step S804, it is judged whether the length of the contact path is smaller than a predetermined value. If the length of the contact path is smaller than the predetermined value, then the control unit outputs the press signal detected in a predetermined time interval T counted from the time instant Tr, but will not output the detected contact path (step S806). If the length of the contact path is not smaller than the predetermined value, then the control unit 102 outputs the detected press signal and contact path (step S808). In the step S806, the control unit can (a) disable the capacitance sensing layer 204 from detecting the contact path, or (b) ignore the contact path detected by the capacitance sensing layer 204 to disable the contact path from being outputted.

To sum up, in this embodiment, if the length of the contact path generated when the user presses the key is smaller than a predetermined length, the control unit 102 judges that the user wants to perform the key input rather than the gesture operation similar to the mouse operation, and thus ignores the contact path generated therewith to prevent the key input point from being affected by the contact path and shifted.

### Third Embodiment

In this embodiment, when the operating body 104 is operated by a user to make both the contact path and the press signal simultaneously generated from the capacitance sensing layer 204 and the resistance sensing layer 206 respectively, if either one of the conditions (a) the length of the contact path is longer than the predetermined length, or (b) the contact path is a multi-touch gesture is satisfied, then the control unit 102 ignores the press signal and outputs the contact path to the host 106. Thus, this embodiment can effectively distinguish between the user's keyboard operation from the user's gesture operation. When the user is performing the gesture operation, the turn-on signal of the unessential key pressing operation generated with the gesture operation can be properly ignored. In addition, it is to be understood that this embodiment can be combined with other embodiments described in the specification.

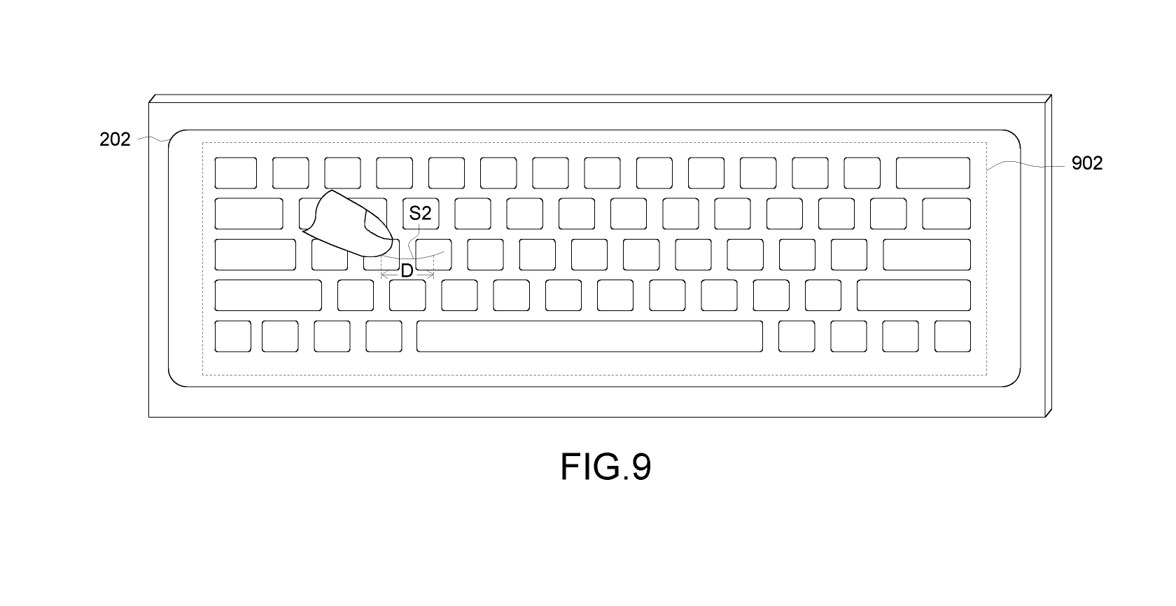

FIG. 9 is a schematic view showing a user operating the keyboard layout layer 202 to generate a contact path with a length S2. Referring to FIG. 9, a keyboard layout 902 has a plurality of keys and the length S2 of the contact path is greater than a distance D between center points of neighboring two of the keys. Taking this distance D (e.g., substantially equal to 18 mm) as an example of the predetermined value, the length S2 of the contact path is greater than the predetermined value, so the control unit 102 disables the resistance sensing layer 206 from generating the press signal. In other words, when the length of the contact path is greater than a predetermined value, the control unit 102 judges that the user is performing the gesture operation (e.g., the long-track sliding operation using the finger) rather than the keyboard operation, and correspondingly disables the resistance sensing layer 206 (by cutting off the power supply of the resistance sensing layer 206, or the control unit 102 ignores the signal from the resistance sensing layer 206 and does not output the corresponding character signal to the host 106) to prevent the gesture operation from incorrectly inputting the keyboard character. The predetermined value is not particularly restricted to a distance between center points of neighboring two of the keys, whereas the predetermined value may also be smaller than a distance between center points of neighboring two of the keys.

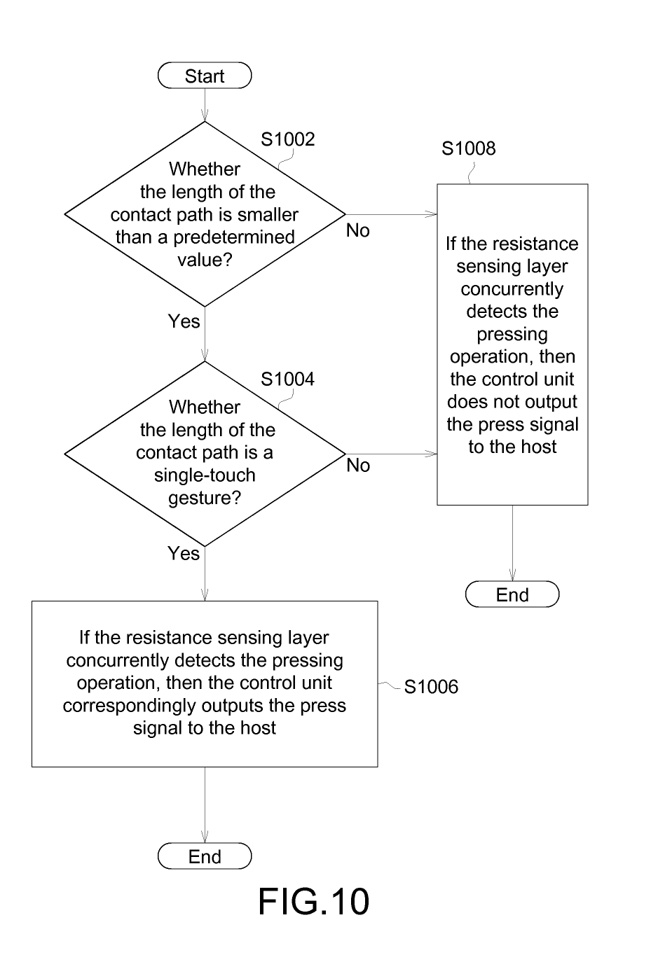

FIG. 10 is a flow chart showing an operating method of a peripheral device according to a third embodiment of the invention. Referring to FIG. 10, the operating method comprises the following steps. First, in step S1002, the resistance sensing layer 206 detects the pressing operation, while the capacitance sensing layer 204 detects the user's gesture operation. Next, in step S1004, it is judged whether the length of the contact path is smaller than the predetermined value. If the length of the contact path is smaller than the predetermined value, then it is judged whether the contact path is the single-touch gesture (step S1006). If the length of the contact path is not smaller than the predetermined value, then the control unit 102 outputs the contact path but does not output the press signal (step S1008). In addition, when the judged result of the step S1006 is affirmative, the control unit 102 outputs the press signal, but does not output the contact path (step S1010). If the judged result of the step S1006 is negative, then the step S1008 is performed next. It is to be understood that although the steps S1004 and S1006 of FIG. 10 are performed in a forward order, the steps S1004 and S1006 may be performed in a reverse order or simultaneously in another example. In the step S1008, the control unit can (a) disable the resistance sensing layer 206 from detecting the press signal, or (b) ignore the press signal detected by the resistance sensing layer 206 to prevent the press signal from being outputted. Similarly, in the step S1010, the control unit can (a) disable the capacitance sensing layer 204 from detecting the contact path, or (b) ignore the contact path detected by the capacitance sensing layer 204 to prevent the contact path from being outputted.

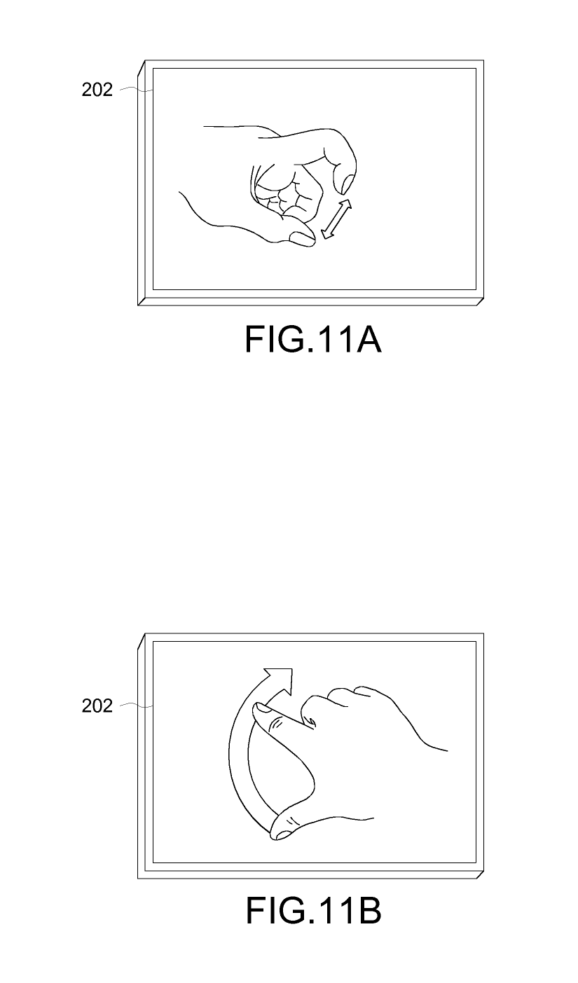

FIG. 11A is a schematic view showing multi-touch gestures of zoom-in and zoom-out finger contacts applied to the keyboard layout layer 202. FIG. 11B is a schematic view showing a multi-touch gesture of a “rotate” finger contact applied to the keyboard layout layer 202. Referring to FIGS. 11A and 11B of this embodiment, as long as the control unit 102 judges that the user is performing the multi-touch finger contact on the keyboard layout layer 202, the control unit 102 disables the resistance sensing layer 206 to prevent the press signal from being generated regardless of whether the length of the contact path is greater than a predetermined value. However, the invention is not restricted thereto. In addition to the zoom-in, zoom-out or “rotate” finger contact, other multi-touch finger contacts corresponding to other touch control functions are also applicable to this embodiment.

To sum up, the peripheral device according to each embodiment of the invention can effectively prevent all possible malfunctions from being generated when the user is performing the gesture operation (similar to the mouse operation) and/or keyboard operation according to various judging conditions and the corresponding control, thereby decreasing the judgment difficulty of the program.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A peripheral device, comprising:
a control unit; and
an operating body, which is electrically coupled to the control unit and comprises:
a keyboard layout layer showing a plurality of keys to be operated, the plurality of keys comprising a modifier key, the keyboard layout layer defining a first operating area and a second operating area, the modifier key is located within the first operating area, but located outside the second operating area;
a capacitance sensing layer disposed beneath the keyboard layout layer capable to detect a finger contact and generate a contact path according to the finger contact; and
a resistance sensing layer, which is disposed under the keyboard layout layer, stacked with the capacitance sensing layer, capable to detect a pressing operation on the keyboard layout layer and generates a press signal according to the pressing operation;
wherein when the resistance sensing layer detects a pressing operation occurs at a location corresponding to the modifier key, the control unit enables the capacitance sensing layer to detect the finger contact in the second operating area to generate the contact path;
wherein when the resistance sensing layer detects no pressing operation occur at the location corresponding to the modifier key, the control unit enables the capacitance sensing layer to detect the finger contact in the first operating area to generate the contact path.

2. The peripheral device according to claim 1, wherein the capacitance sensing layer having a plurality of electrodes, the electrodes comprise a plurality of column electrodes and a plurality of row electrodes, and when the resistance sensing layer detects the pressing operation occurs at the location corresponding to the modifier key, the control unit disables a portion of the column electrodes and a portion of the row electrodes passing through the location corresponding to the modifier key.

3. The peripheral device according to claim 2, wherein after the pressing operation ends for an interval exceeding a predetermined time interval, the control unit enables the disabled portion of the column electrodes and the disabled portion of the row electrodes again.

4. The peripheral device according to claim 1, wherein the control unit comprises:
a capacitance sensing layer control module for controlling the electrodes of the capacitance sensing layer, the electrodes comprising a plurality of column electrodes and a plurality of row electrodes; and
a resistance sensing layer control module for providing a press position signal to the capacitance sensing layer control module according to the pressing operation detected by the resistance sensing layer;
wherein when the capacitance sensing layer control module selectively disables a portion of the column electrodes and a portion of the row electrodes according to the press position signal, but the other portion of the column electrodes and the other portion of the row electrodes corresponding to the second operating area are still enabled.

5. The peripheral device according to claim 1, wherein the keyboard layout layer further comprising a modified key area which is the difference between the first operating area and the second operating area, and the modifier key is located in the modifier key area.

6. The peripheral device according to claim 5, wherein the second operating area comprises 26 English alphabet keys and 10 numeric keys, the modifier key area is an L-shaped area located on the lower left side of the second operating area, and at least one of a Shift key, a Ctrl key and an Alt key is located within the L-shaped area.

7. The peripheral device according to claim 1, wherein
when the resistance sensing layer detects the pressing operation occurs at the location corresponding to the modifier key, the control unit enables (a) the resistance sensing layer to detect the pressing operation in the first operating area to generate the press signal, and (b) the capacitance sensing layer to detect the finger contact in the second operating area to generate the contact path; and
when the resistance sensing layer detects no pressing operation occurs at the location corresponding to the modifier key, the control unit enables (a) the resistance sensing layer to detect the pressing operation in the first operating area to generate the press signal, and (b) the capacitance sensing layer to detect the finger contact in the first operating area to generate the contact path.

8. The peripheral device according to claim 1, wherein the capacitance sensing layer further detects a touch force of the finger contact; when the finger contact is a single-touch gesture and the touch force is smaller than a touch threshold value, it represents that a left key of a mouse is operated; and when the finger contact is a multi-touch gesture and the touch force is smaller than the touch threshold value, it represents that a right key of the mouse is operated.

9. A peripheral device which can be connected to a host, the peripheral device comprising:
a control unit; and
an operating body electrically connected to the control unit, the operating body comprising:
a keyboard layout layer showing a plurality of keys to be operated;
a capacitance sensing layer, which is disposed under the keyboard layout layer for detecting a finger contact to generate a contact path; and
a resistance sensing layer, which is disposed under the keyboard layout layer, stacked with the capacitance sensing layer, and is for detecting a pressing operation on the keyboard layout layer to generate a press signal;
wherein when the operating body operated by a user to make the press signal and the contact path simultaneously generated, and the length of the contact path is shorter than a predetermined length, then the control unit ignores the contact path and only outputs the press signal to the host.

10. The peripheral device according to claim 9, wherein when the resistance sensing layer detects the pressing operation at a starting time point, the control unit keeps ignoring the contact path for a predetermined time interval since the starting time point.

11. The peripheral device according to claim 9, wherein the predetermined length substantially ranges from 3 mm to 5 mm.

12. The peripheral device according to claim 9, wherein a position of the pressing operation detected by the resistance sensing layer at a location corresponding to a first key in the keyboard layout, and the press signal outputted from the control unit to the host is a key code corresponding to the first key.

13. The peripheral device according to claim 9, wherein the resistance sensing layer comprising a switch, when the external force exceeds a press threshold value, the switch in the resistance sensing layer is turned on representing the pressing operation is detected.

14. The peripheral device according to claim 13, wherein the press threshold value is substantially equal to 60 grams.

15. The peripheral device according to claim 9, wherein the capacitance sensing layer further detects a touch force of the finger contact; when the finger contact is a single-touch gesture and the touch force is smaller than a touch threshold value, it represents that a left key of a mouse is operated; and when the finger contact is a multi-touch gesture and the touch force is smaller than the touch threshold value, it represents that a right key of the mouse is operated.

16. A peripheral device, which can be connected to a host, the peripheral device comprising:
a control unit; and
an operating body electrically coupled to the control unit, the operating body comprising:
a keyboard layout layer showing a plurality of keys to be operated;
a capacitance sensing layer disposed under the keyboard layout layer for detecting a finger contact to generate a contact path; and
a resistance sensing layer disposed under the keyboard layout layer and stacked with the capacitance sensing layer, for detecting a pressing operation on the keyboard layout layer to generate a press signal;
wherein when both the contact path and the press signal are simultaneously generated,
when (a) a length of the contact path is smaller than a predetermined value, and (b) the contact path is a single-touch gesture, the control unit ignores the contact path and outputs the press signal to the host;
wherein when (a) the length of the contact path is greater than the predetermined value, or (b) the contact path is a multi-touch gesture, the control unit ignores the press signal and outputs the contact path to the host.

17. The peripheral device according to claim 16, wherein the predetermined value is smaller than a distance between center points of neighboring two of the keys.

18. The peripheral device according to claim 17, wherein the predetermined value is substantially equal to 18 mm.

19. The peripheral device according to claim 16, wherein when the length of the contact path is greater than the predetermined value, the control unit disables the resistance sensing layer from generating the press signal.

20. The peripheral device according to claim 16, wherein the multi-touch gesture comprises a zoom-in finger contact, a zoom-out finger contact and a “rotate” finger contact.

21. The peripheral device according to claim 16, wherein the capacitance sensing layer further detects a touch force of the finger contact; when the finger contact is a single-touch gesture and the touch force is smaller than a touch threshold value, it represents that a left key of a mouse is operated; and when the finger contact is a multi-touch gesture and the touch force is smaller than the touch threshold value, it represents that a right key of the mouse is operated.
